(19) United States
(12) Patent Application Publication
(10) Pub. No.: US 2014/0033498 A1
(43) Pub. Date: Feb. 6, 2014

(54) HANDLE ASSEMBLY AND RELATED METHODS OF USE AND MANUFACTURE

(71) Applicants: David A. Coffin, Murrieta, CA (US); Douglas W. Wilson, San Dimas, CA (US); Megen M. Lee, Brooklyn, NY (US)

(72) Inventors: David A. Coffin, Murrieta, CA (US); Douglas W. Wilson, San Dimas, CA (US); Megen M. Lee, Brooklyn, NY (US)

(21) Appl. No.: 13/565,764

(22) Filed: Aug. 2, 2012

(51) Int. Cl. A47B 95/02; B23P 15/00; B23P 11/00; B21D 53/00

(52) U.S. Cl. 29/428; 16/417; 72/324; 72/47

(57) ABSTRACT

A handle assembly and related methods of use and manufacture. According to one embodiment, the handle assembly can include a mount that is configured to be secured to an object, such as a wall of a drawer. The mount can include a spine. The spine, in turn, can include a top surface. A ramp can extend from a first side of the mount, and a handle can extend from a second side of the mount.

### FIELD OF THE INVENTION

The present invention relates generally to a handle assembly, as well as to methods of making and using the handle assembly.

### BACKGROUND

There are many situations in which it can be desirable to store one or more types of items, such as, but not limited to, paper documents (e.g., receipts, coupons, notepads, writing pads, stationery, index cards, etc.), recording media (e.g., DVDs, CDs, flash drives, floppy discs, etc.), plastic cards (gift cards, credit cards, identification cards, security cards, etc.), and miscellaneous office supplies and/or personal effects (e.g., writing utensils, scissors, erasers, tape dispensers, labels, photographs, souvenirs, etc.). Oftentimes, it is desirable to organize a plurality of the items one wishes to store by storing some of the items in one storage space and storing other of the items in another storage space.

Various storage assemblies have been devised for storing items of the types identified above. One such storage assembly includes a tray divided into a plurality of compartments. The compartments can be of the same size or can be of different sizes. Another type of storage assembly includes a plurality of trays arranged in a stack. Such a stacked-tray type of storage assembly can be used, for example, to organize documents of the same paper size into different categories. Still another type of storage assembly includes a frame having a plurality of compartments and a drawer slidably mounted in each of the compartments. The frame can be constructed so that the slidable drawers are arranged in a vertical stack and/or can be constructed so that the slidable drawers are arranged in a horizontal row. Oftentimes, a handle is affixed to the slidable drawer to facilitate opening and closing the drawer.

### SUMMARY

The present invention includes a handle assembly. The handle assembly can include a mount that is configured to be secured to an object. The mount can include a spine. The spine can include a top surface. A ramp can extend from a first side of the mount. A handle can extend from a second side of the mount.

In other, more detailed features of the invention, the mount can include a clip dimensioned to be frictionally fitted onto the object.

In other, more detailed features of the invention, the mount can further include a first tab and a second tab. In other, more detailed features of the invention, the spine can further include opposing first and second edges, the first tab can extend from the first edge, and the second tab can extend from the second edge. In other, more detailed features of the invention, the spine, the first tab, and the second tab can collectively form a first clip that is dimensioned to be frictionally fitted onto the object.

In other, more detailed features of the invention, the ramp can extend from the first edge of the spine, and the handle can extend from the second edge of the spine.

In other, more detailed features of the invention, the mount can further include a third tab and a fourth tab. In other, more detailed features of the invention, the third tab can be spaced apart from the first tab and can extend from the first edge of the spine, and the fourth tab can be spaced apart from the second tab and can extend from the second edge of the spine. In other, more detailed features of the invention, the spine, the second tab, and the fourth tab can collectively form a second clip that is dimensioned to be frictionally fitted onto the object.

In other, more detailed features of the invention, the spine can include a first notch and a second notch. In other, more detailed features of the invention, the first notch can be disposed between the first tab and the ramp, and the second notch can be disposed between the third tab and the ramp.

In other, more detailed features of the invention, the spine can further include a third notch and a fourth notch. In other, more detailed features of the invention, the third notch can be disposed between the second tab and the handle, and the fourth notch can be disposed between the fourth tab and the handle.

In other, more detailed features of the invention, the first tab can have a height measured from the first edge, the second tab can have a height measured from the second edge, and the height of the first tab can be greater than the height of the second tab.

In other, more detailed features of the invention, a ratio of the height of the second tab to the height of the first tab can be approximately 0.3 to approximately 0.5.

In other, more detailed features of the invention, the first tab can have a shape selected from the group consisting of rectangular, semi-circular, semi-elliptical, and triangular, and the second tab can have a shape selected from the group consisting of rectangular, semi-circular, semi-elliptical, and triangular.

In other, more detailed features of the invention, the first tab can be rectangular, and the second tab can be rectangular.

In other, more detailed features of the invention, the ramp can be angled downwardly from the top surface of the spine at an angle of approximately 20 degrees to approximately 70 degrees.

In other, more detailed features of the invention, the ramp can be angled downwardly from the top surface of the spine at an angle of approximately 30 degrees to approximately 60 degrees.

In other, more detailed features of the invention, the ramp can be angled downwardly from the top surface of the spine at an angle of approximately 40 degrees to approximately 50 degrees.

In other, more detailed features of the invention, the ramp can be angled downwardly from the top surface of the spine at an angle of approximately 45 degrees.

In other, more detailed features of the invention, the ramp can be angled downwardly from the top surface of the spine at an angle of approximately 35 degrees.

In other, more detailed features of the invention, the ramp can include an embossment proximate to the first side of the mount.

In other, more detailed features of the invention, the ramp can have a shape selected from the group consisting of semi-circular, semi-elliptical, triangular, rounded triangular, rectangular, rounded rectangular, and concave.

In other, more detailed features of the invention, the ramp can be semi-circular in shape.

In other, more detailed features of the invention, the ramp can have a width, and the ramp can be flat across its width.

In other, more detailed features of the invention, the ramp can have a width, and the ramp can be arched across its width.

In other, more detailed features of the invention, the ramp can have a generally straight profile in end view.

In other, more detailed features of the invention, the handle can have a shape selected from the group consisting of knob-shaped, loop-shaped, hook-shaped, and rod-shaped.

In other, more detailed features of the invention, the handle can be hook-shaped.

In other, more detailed features of the invention, the mount, the handle, and the ramp can be part of a one-piece structure.

In other, more detailed features of the invention, the one-piece structure can be made of a rigid material.

In other, more detailed features of the invention, the rigid material can be selected from the group consisting of metals, metal alloys, polymers, polymer blends, and polymer alloys.

In other, more detailed features of the invention, the rigid material can be selected from the group consisting of steel, copper, brass, aluminum, acrylonitrile butadiene styrene, polypropylene, and nylon.

The present invention also includes a method of manufacturing a handle assembly. The method can include providing a sheet of material, cutting the sheet of material to form a planar profile, the planar profile including a first side section, a second side section, and an intermediate section, bending the first side section to form a first tab, bending the second side section to form a second tab, bending the intermediate section to form a ramp, bending the first side section to form a third tab, bending the second side section to form a fourth tab, and bending the intermediate section to form a handle.

In other, more detailed features of the invention, the bending of the first side section to form the first tab can be performed before the bending of the first side section to form the third tab.

In other, more detailed features of the invention, the bending of the second side section to form the second tab can be performed before the bending of the second side section to form the fourth tab.

In other, more detailed features of the invention, the bending of the first side section to form the first tab, the bending of the second side section to form the second tab, and the bending of the intermediate section to form the ramp can be performed simultaneously and can be performed prior to the bending of the intermediate section to form the handle.

In other, more detailed features of the invention, the bending of the first side section to form the third tab and the bending of the second side section to form the fourth tab can be performed simultaneously and can be performed prior to the bending of the intermediate section to form the handle.

In other, more detailed features of the invention, the method can further include, after the bending steps, the step of batch plating nickel onto the bent profile.

In other, more detailed features of the invention, the method can further include batch applying a clear coat over the plated nickel.

In other, more detailed features of the invention, the bending of the intermediate section to form the ramp can include bending the intermediate section to define an angle of approximately 20 degrees to approximately 70 degrees.

In other, more detailed features of the invention, the bending of the intermediate section to form the ramp can include bending the intermediate section to define an angle of approximately 30 degrees to approximately 60 degrees.

In other, more detailed features of the invention, the bending of the intermediate section to form the ramp can include bending the intermediate section to define an angle of approximately 40 degrees to approximately 50 degrees.

In other, more detailed features of the invention, the bending of the intermediate section to form the ramp can include bending the intermediate section to define an angle of approximately 45 degrees.

In other, more detailed features of the invention, the bending of the intermediate section to form the ramp can include bending the intermediate section to define an angle of approximately 35 degrees.

In other, more detailed features of the invention, the sheet of material can include a thin sheet of steel.

In other, more detailed features of the invention, the sheet of material can have a thickness of approximately 0.030 inch.

The present invention also includes a method of attaching a handle assembly to an object having a wall. The method can include providing an object having a wall, the wall having a top surface, a front surface, and a rear surface. The method can also include providing a handle assembly. The handle assembly can include a spine, the spine having first and second edges and a top surface between the first and second edges, a first tab, the first tab extending generally downwardly from the first edge, a second tab, the second tab extending generally downwardly from the second edge, wherein the spine, the first tab, and the second tab collectively form a clip mountable on the wall, a ramp angled downwardly from the top surface and along the first edge, and a handle extending from the second edge. The method can also include positioning the handle assembly relative to the wall such that the first tab is contact with the front surface of the wall and such that the second tab extends across the top surface of the wall. The method can also include rotating the handle assembly relative to the wall, whereby the handle assembly is fully mounted on the wall without needing additionally to be slid onto the wall.

The embodiments of the present invention described below are not intended to be exhaustive or to limit the invention to the precise forms disclosed in the following detailed description. Rather, the embodiments are chosen and described so that others who are skilled in the art can appreciate and understand the principles and practices of the present invention. Other features and advantages of the present invention will become apparent to those skilled in the art from the following description of the preferred embodiments taken in conjunction with the accompanying drawings, which illustrate, by way of example, the principles of the invention, the invention not being limited to any particular preferred embodiment(s) disclosed. Many changes and modifications within the scope of the present invention can be made without departing from the spirit thereof, and the invention includes all such modifications.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. It should be noted that the drawings are not necessarily drawn to scale. In the drawings wherein like reference numerals represent like parts:

FIG. 1(a) is a front perspective view of an embodiment of a storage assembly constructed according to the present invention, the storage assembly including an embodiment of a slidable drawer and an embodiment of a handle assembly, the slidable drawer being shown in a closed state;

FIG. 1(b) is a partly exploded perspective view of the storage assembly of FIG. 1(a);

FIG. 1(c) is a section view of the storage assembly of FIG. 1(a) taken along line 1-1;

FIG. 1(d) is a front perspective view of the storage assembly of FIG. 1(a), with the slidable drawer being shown in a partially opened state;

FIGS. 2(a) through 2(h) are front perspective, rear perspective, front, rear, top, bottom, right side, and left side views, respectively, of the embodiment of the handle assembly shown in FIGS. 1(a) through 1(d);

FIG. 3 is a rear perspective view of an alternate embodiment to the handle assembly shown in FIGS. 2(a) through 2(h);

FIG. 4 is a flowchart, schematically depicting one method of making the handle assembly of FIGS. 2(a) through 2(h);

FIGS. 5(a) through 5(f) are views illustrating certain steps of the method of FIG. 4;

FIG. 6 is a flowchart, schematically depicting one method that can be used according to the present invention to attach the handle assembly of FIGS. 2(a) through 2(h) to the slidable drawer shown in FIGS. 1(a) through 1(d);

FIGS. 7(a) and 7(b) are side elevational views illustrating certain steps of the method of FIG. 6;

FIG. 8 is a flowchart, schematically depicting one method that can be used according to the present invention to use the storage assembly of FIGS. 1(a) through 1(d); and

FIG. 9(a) is a section view of the storage assembly of FIG. 1(d) taken along line 2-2; and

FIG. 9(b) is an enlarged side section view of the storage assembly of FIGS. 1(a) through 1(d), illustrating the manner in which the ramp of the handle assembly lifts the top wall of the frame to facilitate closure of the drawer.

### DETAILED DESCRIPTION

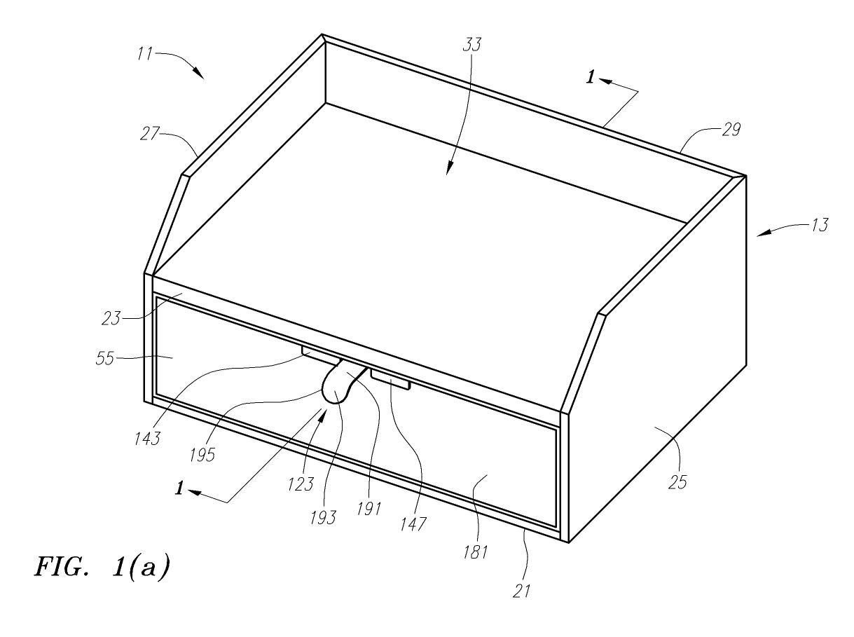

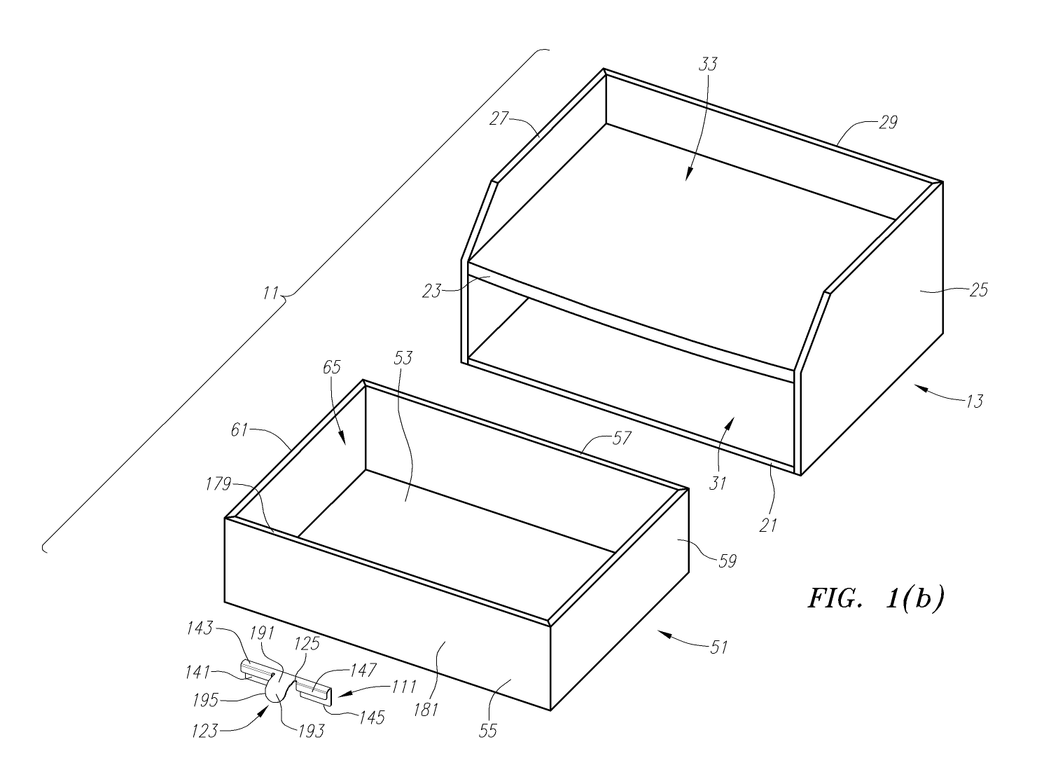

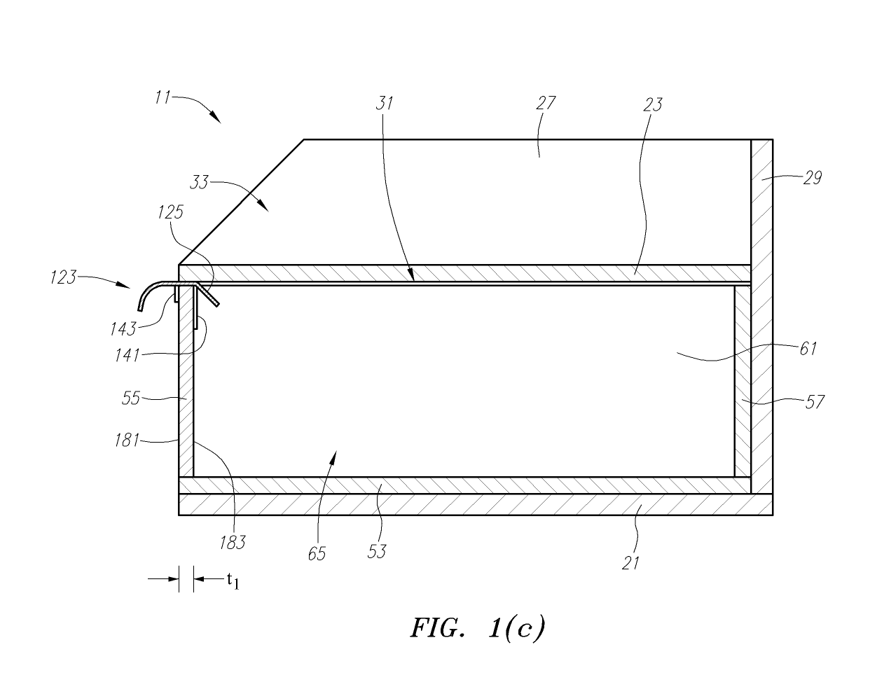

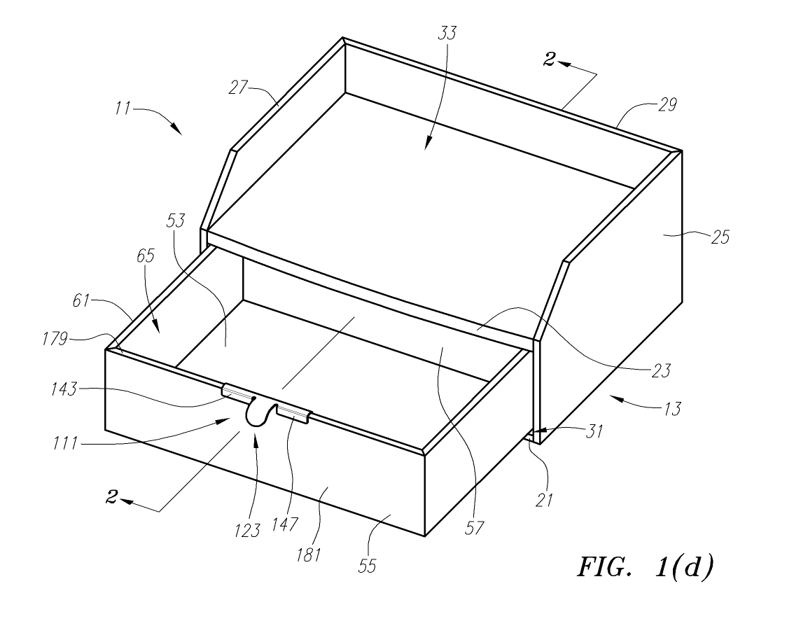

The present invention is directed, in part, at a storage assembly that includes a frame including a compartment and that also includes a drawer that is slidably mounted in the compartment, wherein the drawer can be opened and closed in a facile and reliable fashion. The present invention is also directed, in part, at a handle assembly that can be mounted, for example, on the aforementioned drawer and that can be used to open and to close the drawer; such a handle assembly can alternatively be mounted on other types of drawers or on objects other than drawers, such as doors and the like. The present invention is further directed, in part, at methods for making and using the aforementioned storage assembly and the aforementioned handle assembly. According to the invention, storage assemblies and handle assemblies that are suitable for use therein can come in a multitude of configurations. A non-limiting embodiment of such a storage assembly and a handle assembly is discussed below, it being understood that additional embodiments are possible and that such embodiments come within the scope of the invention. Referring now to FIGS. 1(a) through 1(d), there are shown various views, respectively, of one embodiment of a storage assembly constructed according to the present invention, the storage assembly being represented generally by reference numeral 11.

Storage assembly 11 can include a frame 13. Frame 13 can be shaped to include a bottom wall 21, a top wall 23, a first side wall 25, a second side wall 27, and a rear wall 29. Each of bottom wall 21, top wall 23, first side wall 25, second side wall 27, and rear wall 29 can consist of a single layer of material or can include a plurality of layers. As an example, each of walls 21, 23, 25, 27, and 29 can be made of one or more layers of cardboard, which cardboard optionally can be covered by a sheet of coated or uncoated paper or by a polymeric film; alternatively, as another example, each of walls 21, 23, 25, 27, and 29 can consist of or can include a material similar in strength and rigidity to cardboard. Suitable alternative materials can include, for example, plastics (for example, acrylonitrile butadiene styrene (ABS), polypropylene, glass-filled polyester, and glass-filled nylon), thin plywood, and thin metal. In other embodiments, the frame 13 or portions of the frame 13 can be injection-molded using materials, such as ABS, polypropylene, and acetal resins. Bottom wall 21, top wall 23, first side wall 25, second side wall 27, and rear wall 29 can together define a lower compartment 31. Lower compartment 31 can have a generally rectangular prismatic shape and can have an open front. Top wall 23, first side wall 25, second side wall 27, and rear wall 29 can together define an upper compartment 33, which can have an open top and an open front. Top wall 23, which defines the bottom of upper compartment 33, can serve as a shelf upon which one or more items to be stored can be seated. However, as can be seen, for example, in FIGS. 1(b) and 1(d), top wall 23 of frame 13 can be susceptible to bowing downwardly due to its own weight. Such downward bowing can be exacerbated by the weight of any items seated on top of top wall 23.

Storage assembly 11 can also include a drawer 51. Drawer 51, which can be appropriately dimensioned for slidable movement within lower compartment 31 of frame 13, can be shaped to include a bottom wall 53, a front wall 55, a rear wall 57, a first side wall 59, and a second side wall 61. Each of walls 53, 55, 57, 59, and 61 can consist of a single layer of material or can include a plurality of layers. As an example, each of walls 53, 55, 57, 59, and 61 can be made of one or more layers of cardboard, which cardboard optionally can be covered by a sheet of coated or uncoated paper or by a polymeric film; alternatively, as another example, each of walls 53, 55, 57, 59, and 61 can consist of or can include a material similar in strength and rigidity to cardboard. Suitable alternative materials can include, for example, plastics (for example, acrylonitrile butadiene styrene (ABS), polypropylene, glass-filled polyester, and glass-filled nylon), thin plywood, and thin metal. In other embodiments, the drawer 51 or portions of the drawer 51 can be injection-molded using materials, such as ABS, polypropylene, and acetal resins. Bottom wall 53, front wall 55, rear wall 57, first side wall 59, and second side wall 61 can together define a compartment 65. Compartment 65 can have a generally rectangular prismatic shape and can have an open top.

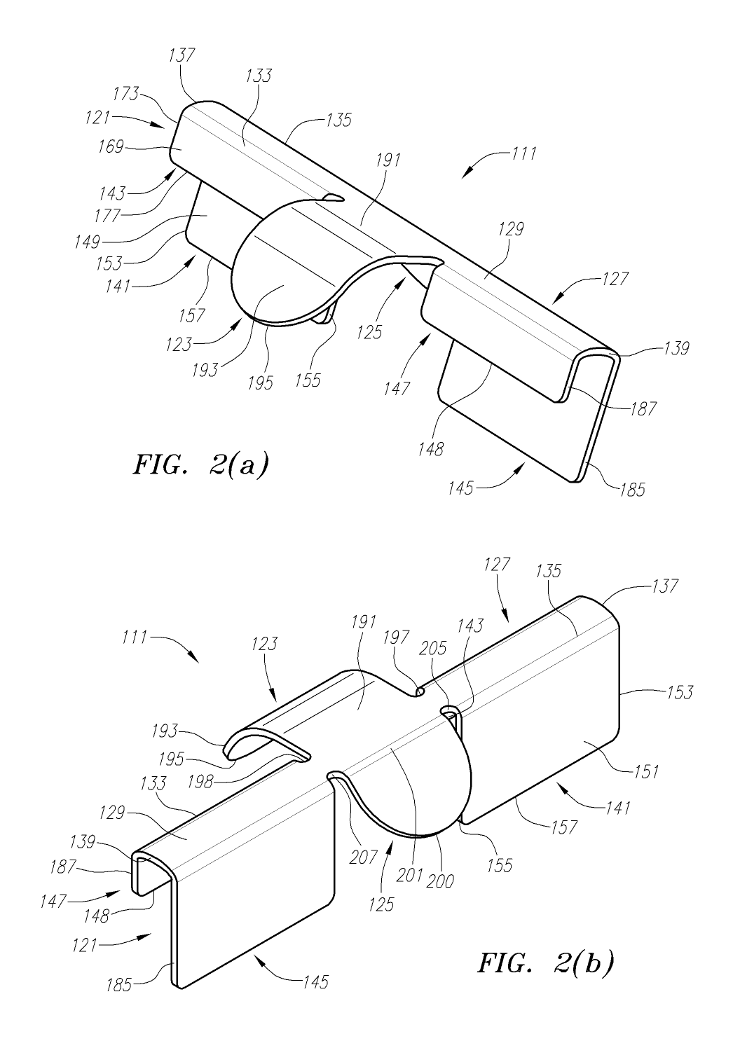

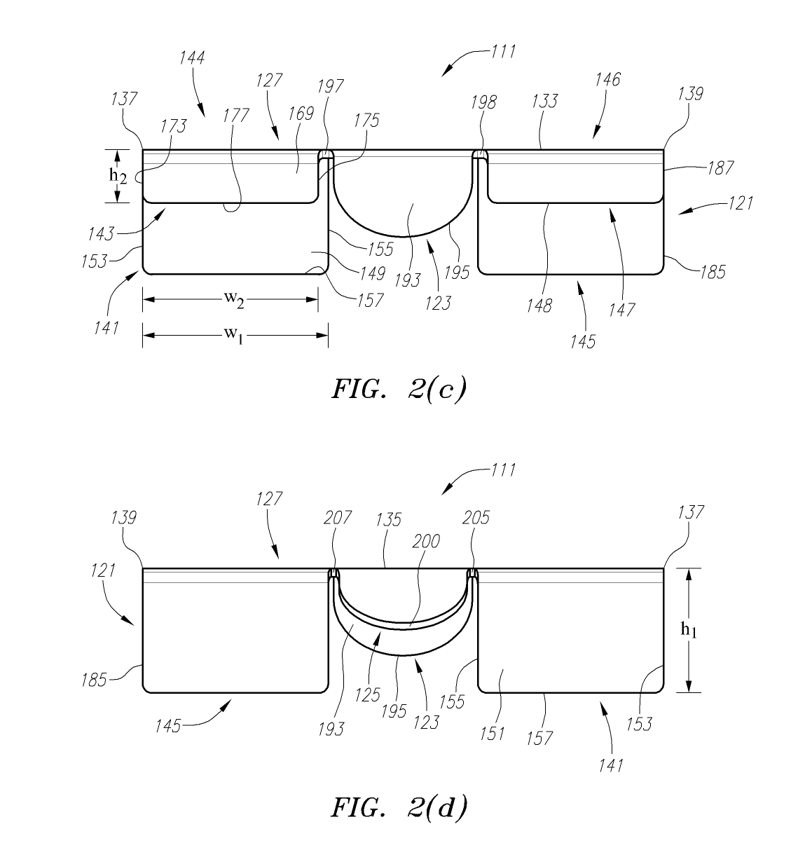

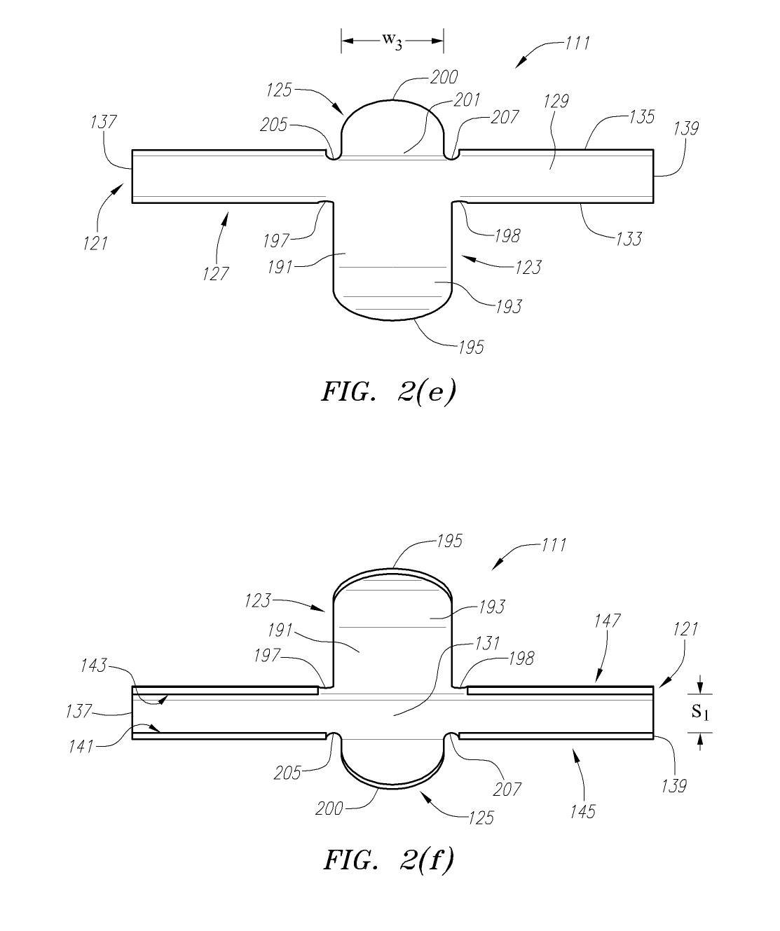

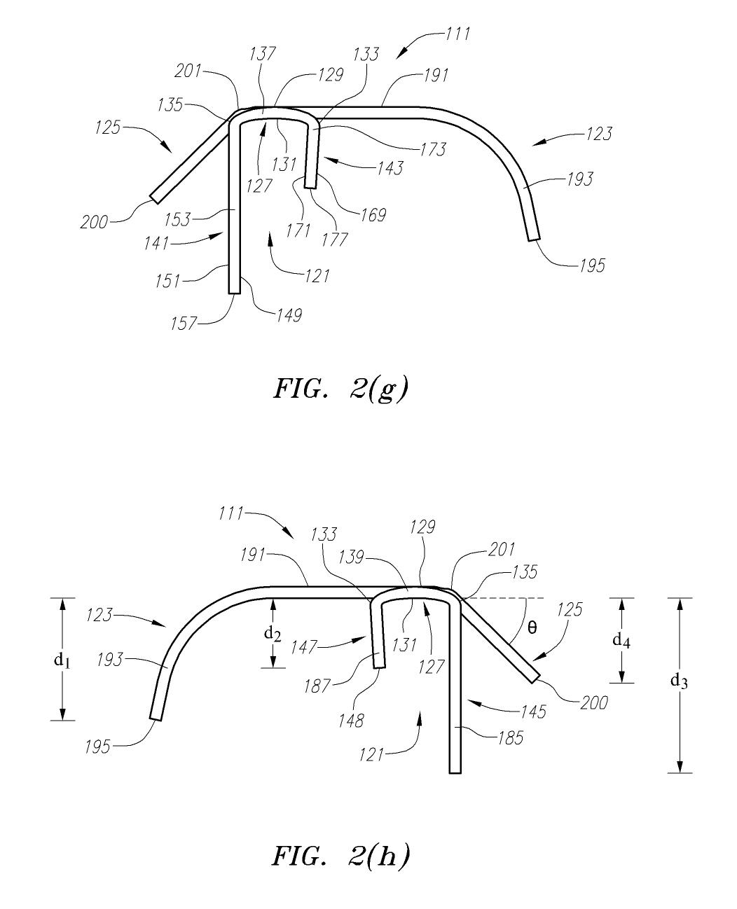

Referring additionally to FIGS. 2(a) through 2(h), storage assembly 11 can further include a handle assembly 111. Handle assembly 111 can include a mount 121, a handle 123, and a ramp 125. Mount 121 can include a spine 127. Spine 127 can be shaped to include a top surface 129, a bottom surface 131, a front edge 133, a rear edge 135, a first end 137, and a second end 139. Spine 127 of mount 121 can be slightly upwardly bowed as viewed from first end 137 of mount 121 (as can be seen in FIG. 2(g)) or from second end 139 of mount 121 (as can be seen in FIG. 2(h)).

Mount 121 can also include a first tab 141, a second tab 143, a third tab 145, and a fourth tab 147. First tab 141 and third tab 145 can be spaced apart from one another and can extend downwardly from rear edge 135 of spine 127, and second tab 143 and fourth tab 147 can be spaced apart from one another and can extend downwardly from front edge 133 of spine 127. First tab 141, which can be generally rectangular in shape, can be shaped to include a front surface 149, a rear surface 151, a first edge 153, a second edge 155, and a third edge 157. Alternatively, first tab 141 can have other shapes; for example, first tab 141 can be semi-circular, semi-elliptical, or triangular, or any other shape. First edge 153 can be flush with first end 137. Second edge 155 can be spaced inwardly from first edge 153. Third edge 157 can interconnect first edge 153 and second edge 155 at their respective distal ends from spine 127. First tab 141 can have a height h₁ extending from the rear edge 135 of the spine 127 to the third edge 157 and can have a width w₁ extending from the first edge 153 to the second edge 155. For illustrative purposes, height h₁ can be, for example, 0.53 inch, and width w₁ can be, for example, 0.81 inch. Second tab 143, which can be generally rectangular in shape, can be shaped to include a front surface 169, a rear surface 171, a first edge 173, a second edge 175, and a third edge 177. Alternatively, second tab 143 can have other shapes; for example, second tab 143 can be semi-circular, semi-elliptical, or triangular, or any other shape. First edge 173 can be flush with first end 137. Second edge 175 can be spaced inwardly from first edge 173. Third edge 177 can interconnect first edge 173 and second edge 175 at their respective distal ends from spine 127. Second tab 143 can have a height h₂ extending from front edge 133 of spine 127 to third edge 177 and can have a width w₂ extending from first edge 173 to second edge 175. Width w₂ of second tab 143 can be approximately equal to or slightly less than width w₁ of first tab 141. For illustrative purposes, height h₂ can be, for example, 0.22 inch, and width w₂ can be, for example, 0.75 inch.

First tab 141 can be oriented generally perpendicularly to spine 127, and second tab 143 can be oriented so that it angles slightly inwardly towards first tab 141 as second tab 143 moves downwardly from spine 127. Alternatively, second tab 143 can be oriented generally perpendicularly to spine 127, and first tab 141 can be oriented so that it angles slightly inwardly towards second tab 143 as first tab 141 moves downwardly from spine 127; alternatively, both first tab 141 and second tab 143 can be oriented so that they angle slightly inwardly towards each other as they move downwardly from spine 127. Tabs 141 and 143, together with the adjoining portion of spine 127, can be appropriately dimensioned to function as a first clip 144 that can be frictionally fitted over a top edge 179 of front wall 55 of drawer 51, as well as against adjacent portions of the front surface 181 and the rear surface 183, respectively, of front wall 55 of drawer 51. For illustrative purposes, where, for example, front wall 55 has a thickness t₁ of approximately 0.19 inch, third edge 157 of first tab 141 and third edge 177 of second tab 143 can be separated by a space s₁ of approximately 0.17 inch. The clamping force of such a clip can be maximized by having the height h₂ of second tab 143 be approximately 0.3 to approximately 0.5 times the height h₁ of first tab 141. First tab 141, in addition to being useful in helping to generate the aforementioned clamping force, can serve to orient handle 123 relative to the front wall 55 of the drawer 51 by generating torque counter to that provided by second tab 143.

Third tab 145 and fourth tab 147 can be sized, shaped and positioned correspondingly to first tab 141 and second tab 143, respectively, except that third tab 145 can have an edge 185 that can be flush with second end 139 of spine 127 (as opposed to being flush with first end 137 of spine 127) and can have other edges that are spaced inwardly from second end 139 of spine 127 and except that fourth tab 147 can have an edge 187 that can be flush with second end 139 of spine 127 (as opposed to being flush with first end 137 of spine 127) and can have other edges that are spaced inwardly from second end 139 of spine 127. Tabs 145 and 147, together with the adjoining portion of spine 127, can be appropriately dimensioned to function as a second clip 146 that can be frictionally fitted over the top edge 179 of front wall 55 of drawer 51, as well as against adjacent portions of the front surface 181 and the rear surface 183, respectively, of front wall 55 of drawer 51.

Handle 123, which can be positioned between second tab 143 and fourth tab 147, can include a first portion 191 and a second portion 193. First portion 191 can be generally flat and flush with spine 127 and can extend generally forwardly from front edge 133 of spine 127. Second portion 193 can extend from first portion 191 and can curve forwardly from first edge 133 of handle assembly 111 and downwardly to a depth d₁ that is intermediate the depth d₂ to which fourth tab 147 extends from first edge 133 of handle assembly 111 and the depth d₃ to which third tab 145 extends from second edge 135 of handle assembly 111. For illustrative purposes, depth d₁ can be, for example, 0.35 inch, depth d₂ can be, for example, 0.19 inch, and depth d₃ can be, for example, 0.5 inch. Second portion 193 can terminate in a rounded edge 195 that can have a radius of curvature of, for example, 0.31 inch. Handle 123 can be appropriately dimensioned to be grasped easily by a user, for example, using the thumb and the forefinger of one hand.

It should be understood that handle 123 is not limited to the shape described above and can be virtually any shape that permits manipulation by a user. Accordingly, handle 123 can be, for example, knob-shaped, loop-shaped, hook-shaped, rod-shaped, or any other functionally equivalent shape.

A notch 197 can be provided in spine 127 between handle 123 and second tab 143, and a notch 198 can be provided in spine 127 between handle 123 and fourth tab 147. Notches 197 and 198 can serve to minimize the distortion to spine 127 that can result from the forming of tabs 143 and 147 in the manner to be discussed below.

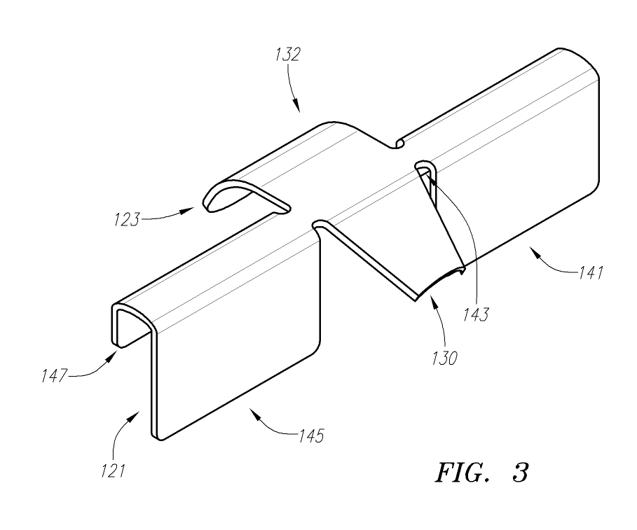

Ramp 125, which can be positioned between first tab 141 and third tab 145, can be appropriately constructed, dimensioned, and oriented to provide some weight-bearing support when placed under another object, such as top wall 23 of frame 13, as will be discussed further below. When viewed from above, ramp 125 can be generally semi-circular (as shown) or can have any of a number of alternate shapes, such as, but not limited to, semi-elliptical, triangular, rounded triangular, rectangular, rounded rectangular, or concave. In addition, when viewed from first end 137 or second end 139 of spine 127, ramp 125 can have a generally straight profile as it extends from rear edge 135 of spine 127 to a distal point 200 or can have a curved profile similar to that of handle 123. Moreover, ramp 125 can be generally flat across its width w₃. Alternatively, as shown in FIG. 3 by ramp 130 of handle assembly 132, the ramp can have an arched profile across its width. For illustrative purposes, width w₃ of ramp 125 can be 0.5 inch, and ramp 125 can have a radius of curvature at distal point 200 of 0.20 inch.

Ramp 125 can extend rearwardly from rear edge 135 of handle assembly 111 and downwardly from the top surface 129 of the spine 127 at an angle 0 that can range from approximately 20 degrees to approximately 70 degrees, or from approximately 30 degrees to approximately 60 degrees, or from approximately 40 degrees to approximately 50 degrees. In one embodiment, angle 0 can be approximately 45 degrees, and in another embodiment, angle 0 can be approximately 35 degrees. Ramp 125 can be shaped to include a ridge or embossment 201 that extends across the width w₃ of ramp 125 proximate to rear edge 135 of spine 127. Ramp 125 can extend downwardly from rear edge 135 of handle assembly 111 to a depth d₄ that is intermediate the depth d₁ to which handle 123 extends downwardly from front edge 133 of handle assembly 111 and the depth d₂ to which tab 147 extends downwardly from front edge 133 of handle assembly 111. Depth d₄ is preferably greater than the depth to which top wall 23 of frame 13 can sag, which, in turn, can be a function of the width of compartment 31 (i.e., the spacing between first side wall 25 of frame 13 and second side wall 27 of frame 13) and the rigidity of the materials forming top wall 23 of frame 13. In this manner, ramp 125 can be inserted below top wall 23 of frame 13 so that top wall 23 of frame 13 can be raised by ramp 125 as drawer 51 is moved to a closed position. For illustrative purposes, depth d₄ of ramp 125 can be, for example, 0.25 inch.

A notch 205 can be provided in spine 127 between ramp 125 and first tab 141, and a notch 207 can be provided in spine 127 between ramp 125 and third tab 145. Notches 205 and 207 can serve to minimize the distortion to spine 127 that can result from the forming of tabs 141 and 145 in the manner to be discussed below.

As will be discussed further below, handle assembly 111 can be formed as a one-piece structure. Materials suitable for use in making handle assembly 111 can include metals, metal alloys, polymers, polymer blends, and/or polymer alloys. Examples of suitable metals can include steel, copper, brass, and aluminum, and examples of suitable polymers can include ABS, polypropylene, and nylon.

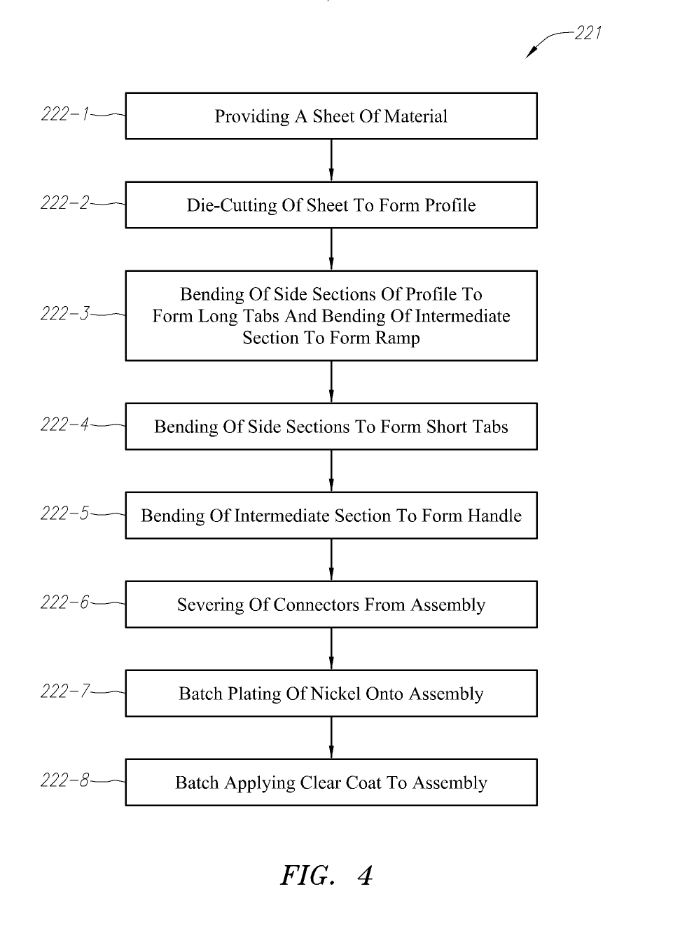

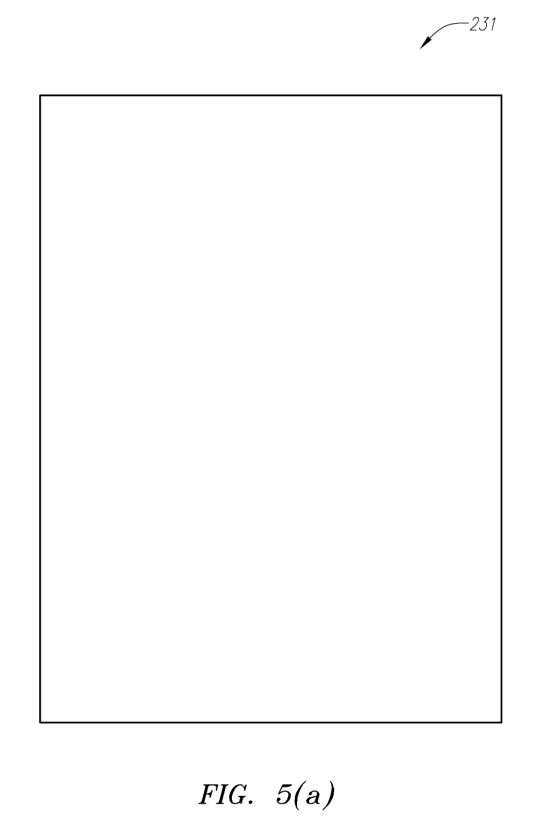

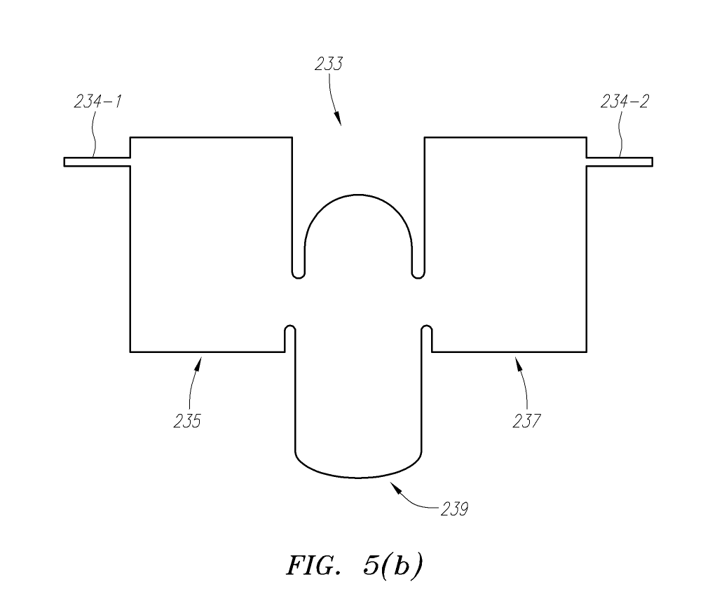

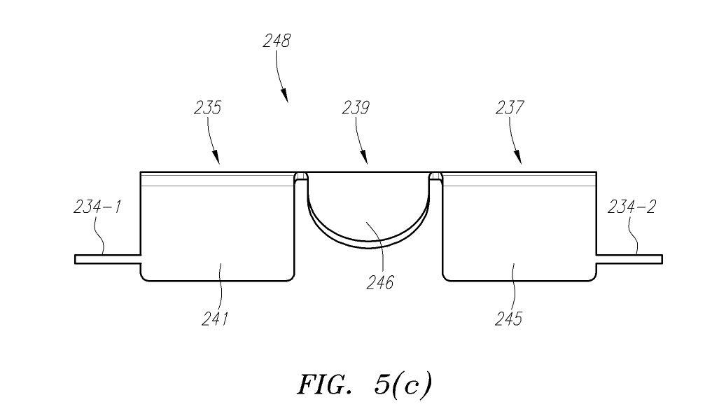

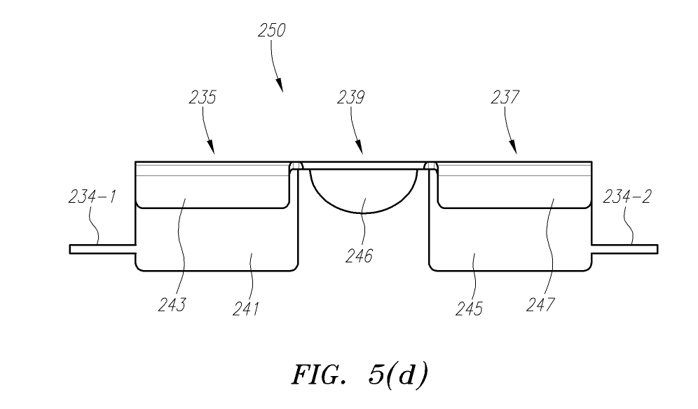

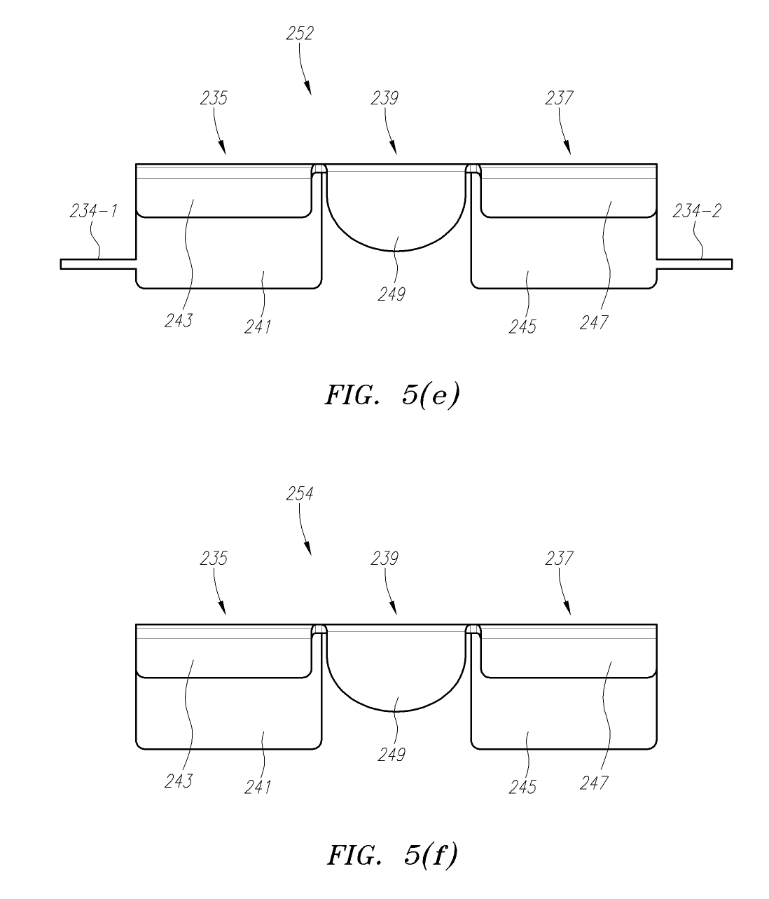

Referring now to FIG. 4, there is shown a flowchart, schematically depicting one embodiment of a method for making handle assembly 111, the method being represented generally by reference numeral 221. Method 221 can begin in a step 222-1 with the provision of a sheet of material 231 (see also FIG. 5(a)). Sheet 231 can consist of a single layer of material or can include a plurality of layers of material. An example of a suitable material for use as sheet 231 can be a sheet of steel, such as a sheet of cold rolled steel, which can have a thickness, for example, of approximately 0.030 inch. Method 221 can then continue in a step 222-2 with the die-cutting of sheet 231 to form a planar profile 233 (see also FIG. 5(b)). Profile 233 can include a pair of connectors 234-1 and 234-2, a first side section 235, a second side section 237, and an intermediate section 239.

Method 221 can then continue in a step 222-3 with the bending of side sections 235 and 237 to form tabs 241 and 245, respectively, and with the bending of intermediate section 239 to form ramp 246 of a first intermediate assembly 248 (see also FIG. 5(c)). (Tabs 241 and 245 and ramp 246 can be similar in size, shape and orientation to tabs 141 and 145 and ramp 125, respectively.) Method 221 can then continue in a step 222-4 with the bending of side sections 235 and 237 to form tabs 243 and 247, respectively, of a second intermediate assembly 250 (see also FIG. 5(d)) (Tabs 243 and 247 can be similar in size, shape and orientation to tabs 143 and 147, respectively.) Where, as discussed above (and as seen best in FIGS. 2(g) and 2(h)), tabs 243 and 247 are angled slightly towards tabs 241 and 245, respectively, the bending of side sections 235 and 237 to form tabs 241 and 245, respectively, in step 222-3 can be an approximately 90-degree bend and the bending of side sections 235 and 237 to form tabs 243 and 247, respectively, in step 222-4 can be a slightly greater than 90-degree bend.

Method 221 can then continue in a step 222-5 with the bending of intermediate section 239 to form handle 249, whereby a third intermediate handle assembly 252 can be formed, third intermediate handle assembly 252 having a similar construction to handle assembly 111, but additionally including connectors 234-1 and 234-2, can be formed (see also FIG. 5(e)). Method 221 can then continue in a step 222-6 with the severing of connectors 234-1 and 234-2, whereby a fourth intermediate handle assembly 254 can be formed (see also FIG. 5(f)). Method 221 can then continue in a step 222-7 with the batch plating of nickel onto fourth intermediate handle assembly 254. The aforementioned nickel plating can be used, for example, to inhibit rusting and can have a thickness of, for example, approximately 0.0005 inch. Method 221 can then conclude in a step 222-8 with the application of a batch applied clear coat to the thus-plated handle assembly to yield handle assembly 111 (see also FIGS. 2(a) through 2(h)). The aforementioned clear coat can be used, for example, to impart gloss and can have a thickness of, for example, 0.002 inch. Such a clear coat can be applied, for example, by spraying or dipping.

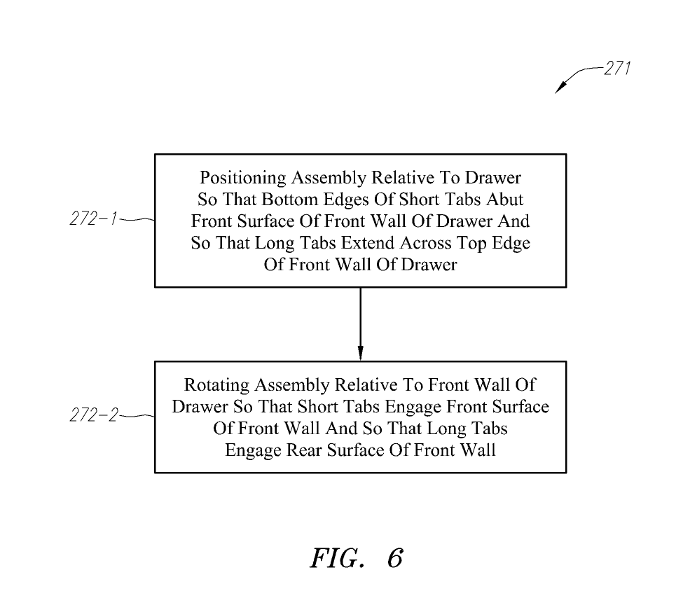

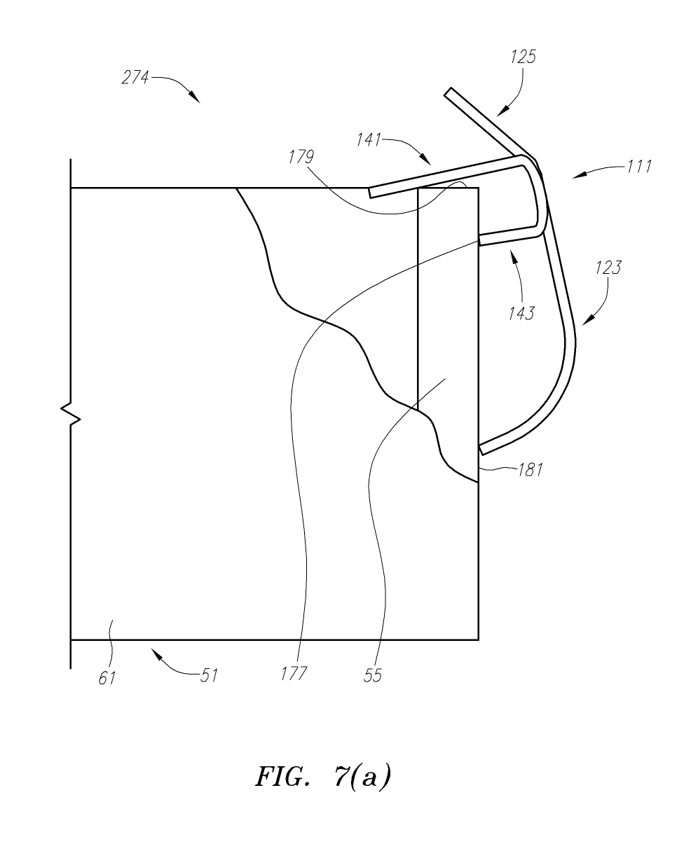

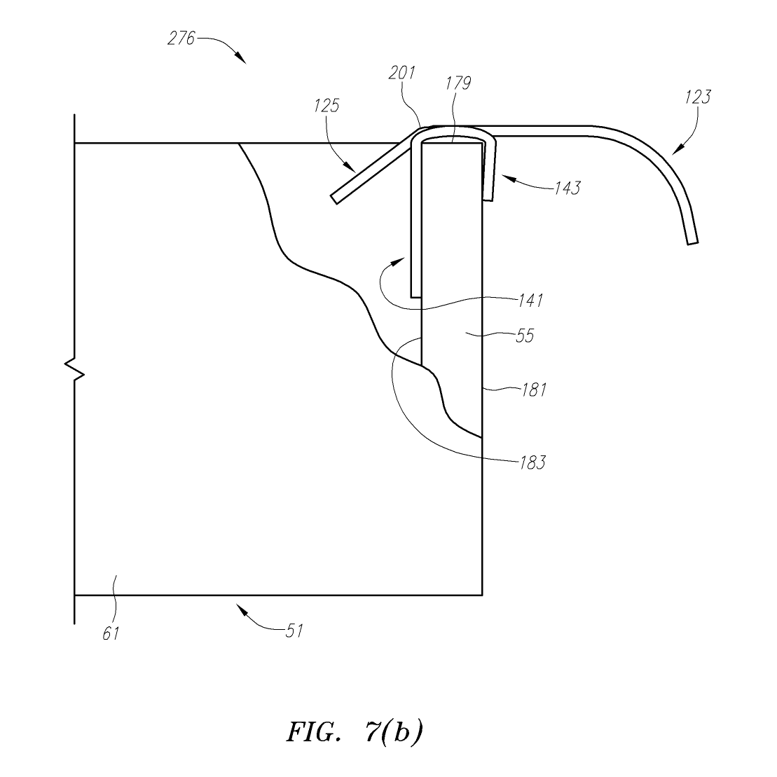

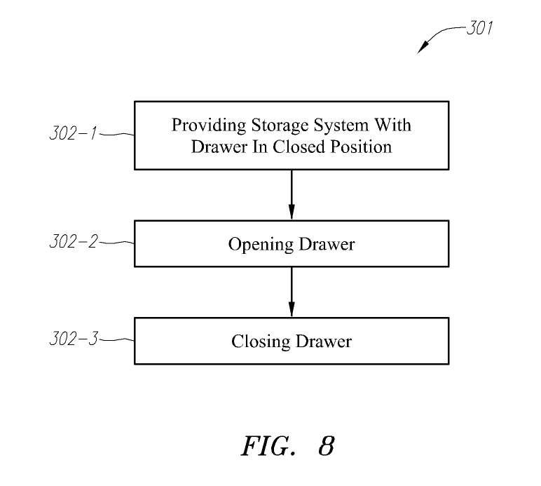

Referring now to FIG. 6, there is shown a flowchart, schematically depicting one embodiment of a method for attaching handle assembly 111 to front wall 55 of drawer 51, the method being represented generally by reference numeral 271. Method 271 can begin in a step 272-1 with the positioning of handle assembly 111 relative to front wall 55 of drawer 51 so that third edge 177 of second tab 143 and the corresponding edge 148 of fourth tab 147 (not shown) are in contact with front surface 181 of front wall 55 of drawer 51 and so that first tab 141 and third tab 145 (not shown) extend across top edge 179 of front wall 55 of drawer 51, thereby yielding an intermediate drawer assembly 274 (see also FIG. 7(a)). Method 271 can then conclude in a step 272-2 with the rotation of handle assembly 111 relative to front wall 55 of drawer 51 so that handle assembly 111 can be clamped onto front wall 55 of drawer 51, thereby yielding a drawer assembly 276 (see also FIG. 7(b)). The aforementioned rotating action facilitates the attachment of handle assembly 111 to front wall 55 of drawer 51 and minimizes the incidence of marring of the front surface of 181 of front wall 55 of drawer 51 by handle assembly 111. Moreover, the aforementioned rotating action obviates the need additionally to slide handle assembly 111 downward since handle assembly 111 is preferably dimensioned relative to front wall 55 of drawer 51 so that, simply by virtue of such rotation, handle assembly 111 is fully installed on front wall 55 of drawer 51. Thus, in this embodiment, the handle assembly 111 is fully mounted on the front wall 55 of drawer 51 solely through rotation without needing additionally to be slid onto the front wall 55 of drawer 51. In another method, the handle assembly 111 can be slid onto the wall 55 of the drawer 51 without rotation.

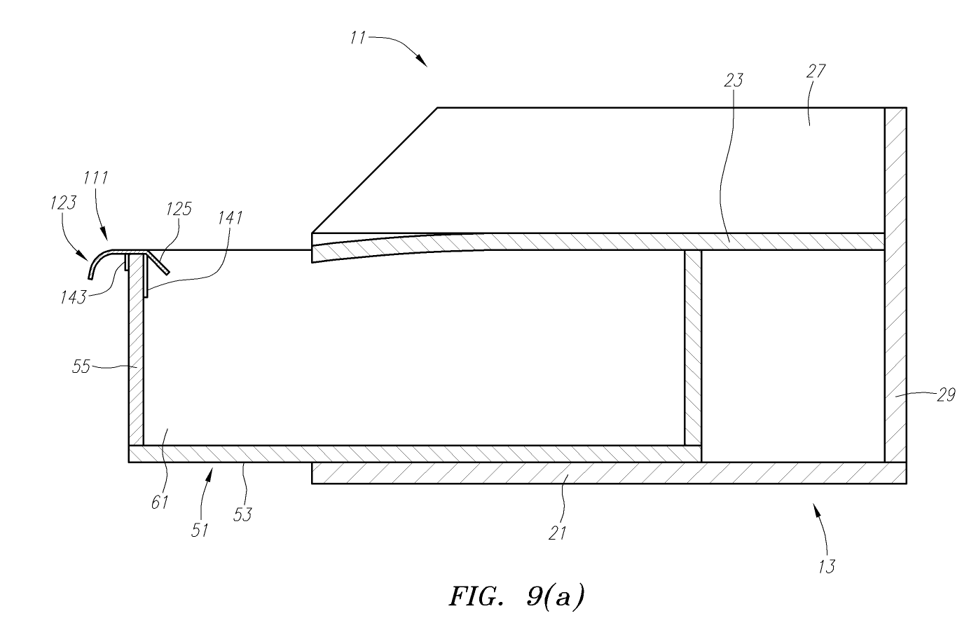

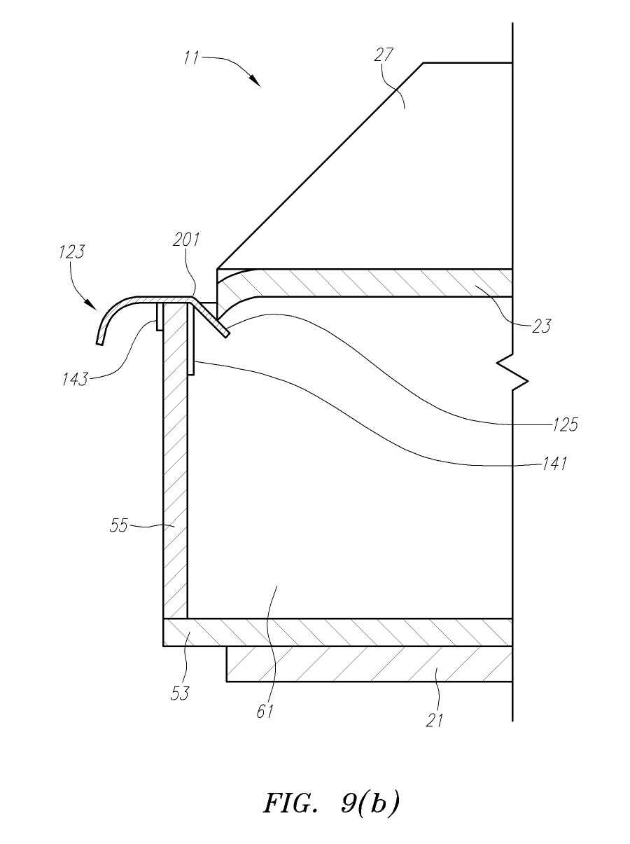

Referring now to FIG. 8, there is shown a flowchart, schematically depicting one embodiment of a method for using storage assembly 11, the method being represented generally by reference numeral 301. Method 301 can begin in a step 302-1 with the provision of storage assembly 11. Although drawer 51 of storage assembly 11 can initially be positioned in either a closed state or an open state, for purposes of the present discussion, drawer 51 is initially placed in a closed state. With drawer 51 in such a closed state, front wall 55 of drawer 51 is positioned directly below top wall 23 of frame 13 (see also FIG. 1(c)). Method 301 can then continue in a step 302-2 with the opening of drawer 51. With drawer 51 thus in an opened state, front wall 55 of drawer 51 is no longer positioned directly below top wall 23 of frame 13. As a result, top wall 23 of frame 13, which is made principally of cardboard or a material having a similar strength and rigidity, tends to bow downwardly into the space vacated by front wall 55 of drawer 51 (see also FIGS. 1(d) and 9(a)). This bowing effect is even greater when objects are placed on top of top wall 23 of frame 13 and, were it not for the design of handle assembly 111, would negatively affect the ability to close drawer 51. Method 301 can then conclude in a step 302-3 with the closing of drawer 51. The closing of drawer 51 is made possible, despite the aforementioned downward bowing of top wall 23 of frame 13, by the action of ramp 125, which, during the rearward sliding of drawer 51, slides under and lifts up top wall 23 of frame 13 sufficiently to enable front wall 55 of drawer 51 to pass under top wall 23 of frame 13 (see also FIG. 9(b)). As drawer 51 completes its closure, top wall 23 of frame 13 is caused to slide over embossment 201, which provides a tactile indication of closure to the person closing drawer 51.

All features disclosed in the specification, including the claims, abstract, and drawings, and all steps in any method or process disclosed, can be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

The foregoing detailed description of the present invention is provided for purposes of illustration, and it is not intended to be exhaustive or to limit the invention to the particular embodiments disclosed. The embodiments can provide different capabilities and benefits, depending on the configuration used to implement the key features of the invention. Accordingly, the scope of the invention is defined only by the following claims.

What is claimed is:

1. A handle assembly comprising:
a mount that is configured to be secured to an object, the mount including a spine, the spine including a top surface;
a ramp extending from a first side of the mount; and
a handle extending from a second side of the mount.

2. The handle assembly according to claim 1, wherein the mount includes a clip dimensioned to be frictionally fitted onto the object.

3. The handle assembly according to claim 1, wherein the mount further includes a first tab and a second tab, wherein the spine further includes opposing first and second edges, the first tab extending from the first edge, the second tab extending from the second edge, and wherein the spine, the first tab, and the second tab collectively form a first clip that is dimensioned to be frictionally fitted onto the object.

4. The handle assembly according to claim 3, wherein the ramp extends from the first edge of the spine and wherein the handle extends from the second edge of the spine.

5. The handle assembly according to claim 3, wherein the mount further includes a third tab and a fourth tab, the third tab spaced apart from the first tab and extending from the first edge of the spine, the fourth tab spaced apart from the second tab and extending from the second edge of the spine, wherein the spine, the second tab, and the fourth tab collectively form a second clip that is dimensioned to be frictionally fitted onto the object.

6. The handle assembly according to claim 5, wherein the spine further includes a first notch and a second notch, the first notch being disposed between the first tab and the ramp, the second notch being disposed between the third tab and the ramp.

7. The handle assembly according to claim 5, wherein the spine further includes a third notch and a fourth notch, the third notch being disposed between the second tab and the handle, the fourth notch being disposed between the fourth tab and the handle.

8. The handle assembly according to claim 3, wherein the first tab has a height measured from the first edge, wherein the second tab has a height measured from the second edge, and wherein the height of the first tab is greater than the height of the second tab.

9. The handle assembly according to claim 8, wherein a ratio of the height of the second tab to the height of the first tab is approximately 0.3 to approximately 0.5.

10. The handle assembly according to claim 3, wherein the first tab has a shape selected from the group consisting of rectangular, semi-circular, semi-elliptical, and triangular, and wherein the second tab has a shape selected from the group consisting of rectangular, semi-circular, semi-elliptical, and triangular.

11. The handle assembly according to claim 3, wherein the first tab is rectangular and wherein the second tab is rectangular.

12. The handle assembly according to claim 1, wherein the ramp is angled downwardly from the top surface of the spine at an angle of approximately 20 degrees to approximately 70 degrees.

13. The handle assembly according to claim 1, wherein the ramp is angled downwardly from the top surface of the spine at an angle of approximately 30 degrees to approximately 60 degrees.

14. The handle assembly according to claim 1, wherein the ramp is angled downwardly from the top surface of the spine at an angle of approximately 40 degrees to approximately 50 degrees.

15. The handle assembly according to claim 1, wherein the ramp is angled downwardly from the top surface of the spine at an angle of approximately 45 degrees.

16. The handle assembly according to claim 1, wherein the ramp is angled downwardly from the top surface of the spine at an angle of approximately 35 degrees.

17. The handle assembly according to claim 1, wherein the ramp includes an embossment proximate to the first side of the mount.

18. The handle assembly according to claim 1, wherein the ramp has a shape selected from the group consisting of semi-circular, semi-elliptical, triangular, rounded triangular, rectangular, rounded rectangular, and concave.

19. The handle assembly according to claim 1, wherein the ramp is semi-circular in shape.

20. The handle assembly according to claim 1, wherein the ramp has a width and wherein the ramp is flat across its width.

21. The handle assembly according to claim 1, wherein the ramp has a width and wherein the ramp is arched across its width.

22. The handle assembly according to claim 1, wherein the ramp has a generally straight profile in end view.

23. The handle assembly according to claim 1, wherein the handle has a shape selected from the group consisting of knob-shaped, loop-shaped, hook-shaped, and rod-shaped.

24. The handle assembly according to claim 1, wherein the handle is hook-shaped.

25. The handle assembly according to claim 1, wherein the mount, the handle, and the ramp are part of a one-piece structure.

26. The handle assembly according to claim 25, wherein the one-piece structure is made of a rigid material.

27. The handle assembly according to claim 26, wherein the rigid material is selected from the group consisting of metals, metal alloys, polymers, polymer blends, and polymer alloys.

28. The handle assembly according to claim 26, wherein the rigid material is selected from the group consisting of steel, copper, brass, aluminum, acrylonitrile butadiene styrene, polypropylene, and nylon.

29. A method of manufacturing a handle assembly, the method comprising the steps of:
providing a sheet of material;
cutting the sheet of material to form a planar profile, the planar profile including a first side section, a second side section, and an intermediate section;
bending the first side section to form a first tab;
bending the second side section to form a second tab;
bending the intermediate section to form a ramp;
bending the first side section to form a third tab;
bending the second side section to form a fourth tab; and
bending the intermediate section to form a handle.

30. The method according to claim 29, wherein the bending of the first side section to form the first tab is performed before the bending of the first side section to form the third tab.

31. The method according to claim 30, wherein the bending of the second side section to form the second tab is performed before the bending of the second side section to form the fourth tab.

32. The method according to claim 31, wherein the bending of the first side section to form the first tab, the bending of the second side section to form the second tab, and the bending of the intermediate section to form the ramp are performed simultaneously and are performed prior to the bending of the intermediate section to form the handle.

33. The method according to claim 32, wherein the bending of the first side section to form the third tab and the bending of the second side section to form the fourth tab are performed simultaneously and are performed prior to the bending of the intermediate section to form the handle.

34. The method according to claim 33, further comprising, after the bending steps, batch plating nickel onto the bent profile.

35. The method according to claim 34, further comprising batch applying a clear coat over the plated nickel.

36. The method according to claim 29, wherein the bending of the intermediate section to form the ramp includes bending the intermediate section to define an angle of approximately 20 degrees to approximately 70 degrees.

37. The method according to claim 29, wherein the bending of the intermediate section to form the ramp includes bending the intermediate section to define an angle of approximately 30 degrees to approximately 60 degrees.

38. The method according to claim 29, wherein the bending of the intermediate section to form the ramp includes bending the intermediate section to define an angle of approximately 40 degrees to approximately 50 degrees.

39. The method according to claim 29, wherein the bending of the intermediate section to form the ramp includes bending the intermediate section to define an angle of approximately 45 degrees.

40. The method according to claim 29, wherein the bending of the intermediate section to form the ramp includes bending the intermediate section to define an angle of approximately 35 degrees.

41. The method according to claim 29, wherein the sheet of material includes a thin sheet of steel.

42. The method according to claim 29, wherein the sheet of material has a thickness of approximately 0.030 inch.

43. A method of attaching a handle assembly to an object having a wall, the method comprising the steps of:
providing the object having a wall, the wall having a top surface, a front surface, and a rear surface;
providing the handle assembly, the handle assembly including:
a spine, the spine having first and second edges and a top surface between the first and second edges,
a first tab, the first tab extending generally downwardly from the first edge,
a second tab, the second tab extending generally downwardly from the second edge, wherein the spine, the first tab, and the second tab collectively form a clip mountable on the wall,
a ramp angled downwardly from the top surface and along the first edge, and
a handle extending from the second edge;
positioning the handle assembly relative to the wall such that the first tab is contact with the front surface of the wall and such that the second tab extends across the top surface of the wall; and
rotating the handle assembly relative to the wall, whereby the handle assembly is fully mounted on the wall without needing additionally to be slid onto the wall.

44. The method according to claim 43, wherein the ramp is angled downwardly from the top surface at an angle of approximately 20 degrees to approximately 70 degrees.

45. The method according to claim 43, wherein the ramp is angled downwardly from the top surface at an angle of approximately 30 degrees to approximately 60 degrees.

46. The method according to claim 43, wherein the ramp is angled downwardly from the top surface at an angle of approximately 40 degrees to approximately 50 degrees.

47. The method according to claim 43, wherein the ramp is angled downwardly from the top surface at an angle of approximately 45 degrees.

48. The method according to claim 43, wherein the ramp is angled downwardly from the top surface at an angle of approximately 35 degrees.
